(19) United States
(12) Patent Application Publication
(10) Pub. No.: US 2018/0246944 A1
(43) Pub. Date: Aug. 30, 2018

(54) SYSTEM AND METHOD FOR THE INGESTION OF INDUSTRIAL INTERNET DATA

(71) Applicant: General Electric Company, Schenectady, NY (US)

(72) Inventors: Sriramakrishna Yelisetti, San Ramon, CA (US); Ramana Venkatesh Sivasubramanian, Pleasanton, CA (US); Luis Ramos, San Ramon, CA (US)

(21) Appl. No.: 15/445,701

(22) Filed: Feb. 28, 2017

(51) Int. Cl. G06F 17/30; G06F 17/27

(52) U.S. Cl. CPC G06F 17/30569; G06F 17/2705

(57) ABSTRACT

Disclosed are systems, methods, and computer program products embodied in computer-readable media that facilitate the ingestion of internet-of-things (IoT) data provided by various data sources in various formats, using device-specific data parsers, selected from a catalog of data parsers based on metadata associated with the respective IoT data sources, to convert the data into a device-generic output format.

### TECHNICAL FIELD

This disclosure relates to systems for ingesting industrial Internet of Things (IoT) data, and specifically to the parsing of IoT data received in various formats.

### BACKGROUND

The industrial Internet of Things connects industrial operational assets, such as, e.g., turbines and jet engines, and their associated sensors, controllers, devices, and applications to the Internet, allowing remote monitoring, diagnostics, and control. For instance, physics-based analytics run on monitored sensor data may serve to measure and optimize operational performance, predict potential problems, conduct preventive maintenance, and safely shut down assets if warranted by detected error conditions. Operational and historical data may also be aggregated and analyzed to create new asset models for better diagnostics and prediction, or to derive insights through big-data applications.

The vast amount of data generated by IoT data sources comes in various types and format standards, and unstructured data is common. Data types include, for example, alerts, event data, time-series data, and device health and monitoring data. To enable processing the data via a generic pipeline shared across different kinds of IoT data sources, the data is conventionally conformed, prior to upload, to specific formatting requirements, which can place a substantial burden of data conversion on the data sources.

### BRIEF DESCRIPTION OF THE INVENTIVE SUBJECT MATTER

Disclosed herein are systems, methods, and computer program products embodied in computer-readable media that facilitate the ingestion of IoT data provided in any format via a generic ingestion pipeline. In accordance with various embodiments, metadata associated with the IoT data source (e.g., a particular IoT device model or vendor) is used, in the ingestion pipeline, to select a suitable device-specific data parser from a parser catalog for converting the (payload) data into one of one or more device-generic output formats (e.g., time-series, binary-large-object, and relational-database formats). Data-format conversions are, in this manner, seamlessly integrated in the data ingestion process, allowing the data sources to upload the data in any input format and, thus, reducing the overhead associated with connecting data sources to the ingestion pipeline. (The term “device-specific,” as used herein, refers to dependence on some attribute of the device (such as, e.g., a device model, type, or vendor), as distinguished from device-generic characteristics of the data ingestion system or components thereof, such as acceptable output formats in data stores of the data ingestion system. The term “device-specific” does not necessarily imply specificity to a single device; rather, multiple devices sharing one or more attributes may use the same device-specific parser adapted to operate on a given device-specific input format.)

Accordingly, one aspect of the inventive subject matter relates to a computer system for data ingestion that includes one or more hardware processors and one or more machine-readable storage media storing a parser catalog, a parser selection engine, and a data ingestion engine communicatively coupled to the parser selection engine and the parser catalog. The parser catalog includes a plurality of device-specific data parsers including instructions which, when executed by the one or more hardware processors, cause the one or more hardware processors to convert data from a plurality of industrial internet devices into one or more device-generic output formats. The parser selection engine includes instructions which, when executed by the one or more hardware processors, causes the one or more hardware processors to automatically select, based on metadata associated with the industrial internet devices, respective associated data parsers among the plurality of device-specific data parsers. The data ingestion engine includes instructions which, when executed by the one or more hardware processors, cause the one or more hardware processors to process the data received from any of the industrial internet devices by forwarding the metadata to the parser selection engine, forwarding the received data, upon selection of the data parser associated with the industrial internet device, to the selected data parser, and providing the data, after conversion by the selected parser into one of the device-generic output formats, as output.

Another aspect of the inventive subject matter relates to a method that includes receiving and processing, at a data ingestion system operating in a computer network, data from a plurality of industrial internet devices connected to the computer network, data formats differing between at least two of the industrial internet devices. Processing the data involves, for each device from the plurality of industrial internet devices, automatically selecting an associated data parser among a plurality of device-specific data parsers based on metadata associated with the respective device, and using the selected data parser to convert the data received from the device into an output data format generic to the industrial internet devices.

Yet another aspect relates to a tangible computer-readable medium storing instructions that, when executed by one or more processors of a computer, cause the computer to perform operations including receiving data from a plurality of industrial internet devices connected to the computer network (data formats of the payload data differing between at least two of the industrial internet devices), and, for each device from the plurality of industrial internet devices, automatically selecting an associated data parser among a plurality of device-specific data parsers based on the metadata associated with the device, and causing the selected data parser to convert the data received from the device into an output data format generic to the industrial internet devices.

### BRIEF DESCRIPTION OF THE DRAWINGS

The foregoing will me more readily understood from the following detailed description of the inventive subject matter, in particular, when taken in conjunction with the accompanying drawings, in which:

FIG. 1 is a block diagram of an example IoT data ingestion system in accordance with various embodiments, shown in the context of an IoT ecosystem.

FIG. 2 is a flow chart of an example method of ingesting IoT data in accordance with various embodiments.

FIG. 3 is a is a block diagram of a machine in the example form of a computer system within which instructions may be executed to cause the machine to perform any one or more of the methodologies discussed herein.

### DETAILED DESCRIPTION

The description that follows presents example systems, methods, techniques, instruction sequences, and machine-readable media (e.g., storing computer program products) that constitute illustrative embodiments. For purposes of explanation, numerous specific details are set forth in order to provide an understanding of various embodiments of the inventive subject matter. It will be evident, however, to those skilled in the art that embodiments of the inventive subject matter may be practiced without these specific details. Further, well-known instruction instances, protocols, structures, and techniques are generally not shown in detail herein.

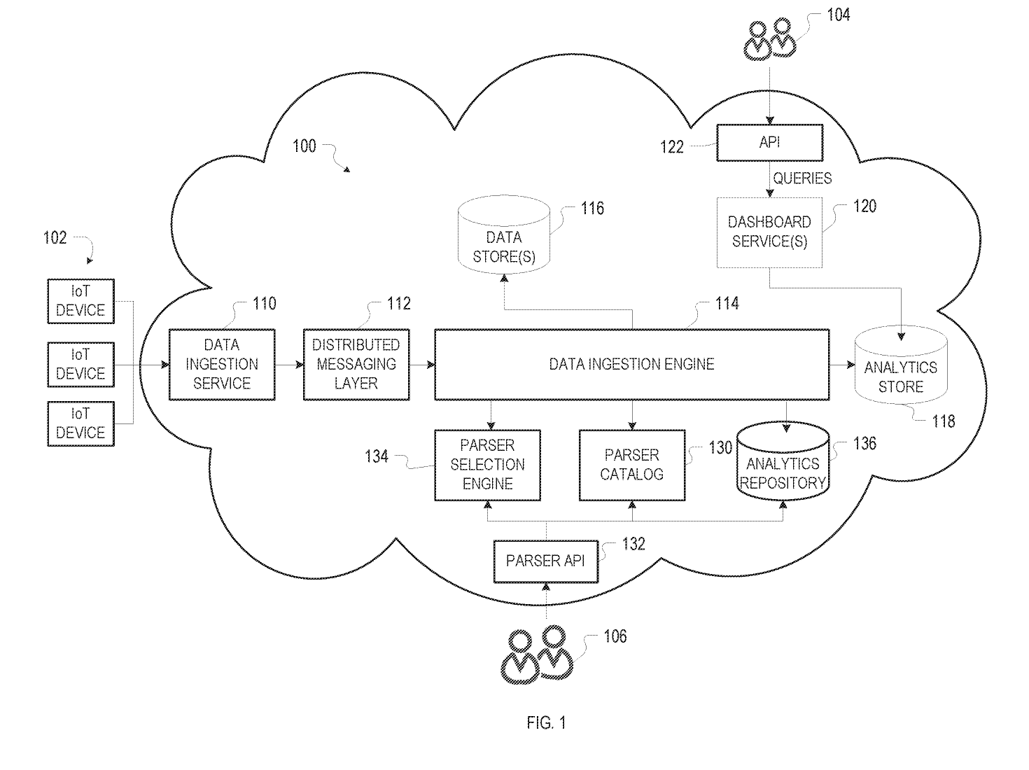

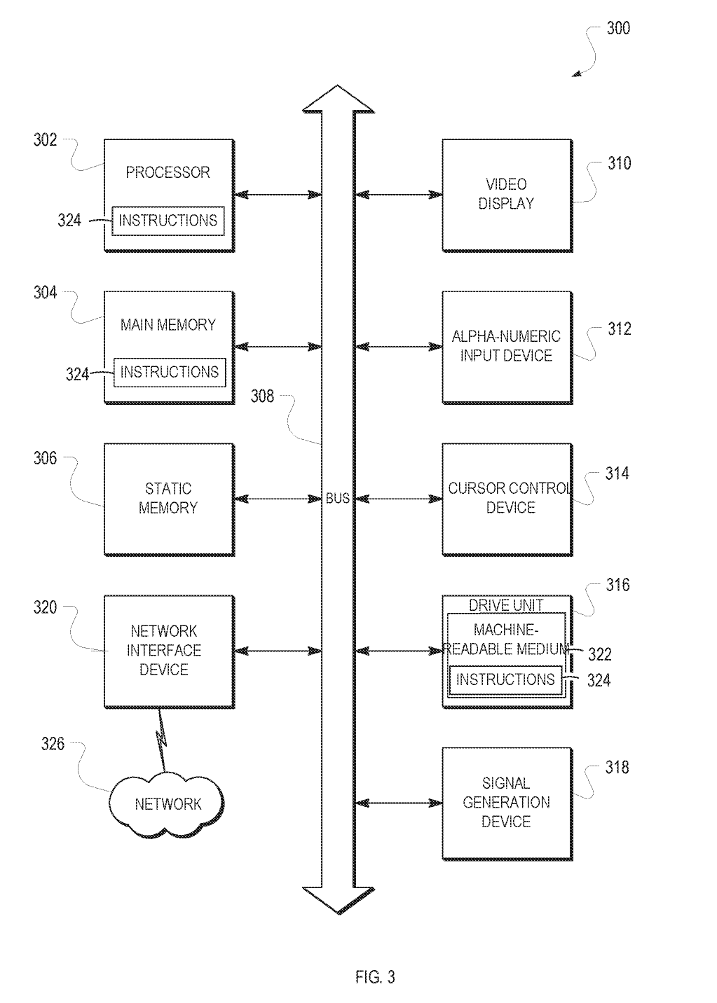

With reference to FIG. 1, an example IoT data ingestion system 100 in accordance with various embodiments is shown in the context of a larger IoT ecosystem. The data ingestion system 100 may be implemented on one or more interconnected computing machines (e.g., a machine as illustrated in FIG. 3) that operate collectively as a server system “in the cloud.” The data ingestion system 100 is connected, via suitable wired or wireless network connections, to a plurality of data sources, that is, to industrial IoT devices 102 from which the system 100 receives IoT data. The data ingestion system 100 is accessible, via a plurality of client computing devices (such as personal computers (PCs) or smart mobile devices) likewise connected to the system 100 through wireless or wired network connections, by field and operations engineers 104, application developers 106, or other authorized personnel affiliated with, e.g., the owners/operators or vendors of the operational assets with which the IoT devices 102 are associated. Field and operations engineers 104 may access the IoT data, e.g., via web portals or mobile applications (“apps”), to monitor and/or control the operational assets, or for similar purposes. Developers 106 of applications operating on the IoT data, or owners/operators or vendors of the assets and associated IoT devices 102, may upload device-specific data parsers for converting the incoming IoT data into one or more device-generic output formats, and/or data-analytics applications configured to process the data (e.g., following conversion into such output format(s)).

Various modules of the data ingestion system 100 may be organized as a data ingestion pipeline. IoT data enters the pipeline through a data ingestion service 110 that acts as a gateway, connecting the IoT devices 102 to the cloud. Via a distributed messaging layer 112, the data is sent to a data ingestion engine 114. The data ingestion service 110 provides an abstraction over the messaging layer 112 to provide security and add additional protocol support, e.g., for industry-specific protocols. It may also allow scaling the ingestion layer to support a large number of devices and/or increasing the velocity of data ingestion. The messaging layer 112 may help to persist the data in a distributed way. It can also act as a defense for the downstream systems in case of a data storm. The messaging layer 112 may aid in supporting different data delivery semantics. It may further offer data segregation and encryption to isolate data and protect them across the different priority groups.

The data ingestion engine 114 stores the data received from the messaging layer 112, usually after suitable format conversion, in an appropriate one of one or more available data stores 116. The available data store(s) 116 may include, for example, a time-series data store, a binary-large-object store, and/or a relational database. Alternatively or additionally to storing the (reformatted) raw data, the data ingestion engine 114 may cause the data to be processed by suitable analytics, and store derived data resulting from the processing in an analytics store 118. For example, time-series data may be aggregated and/or averaged on various time scales to discover trends or periodicities, and relational data may be analyzed to discover correlations between monitored parameters; derived data characterizing the trends, correlations, and the like may be recorded in the analytics store 118. One or more optional dashboard services 120, exposed to users such as field and operations engineers 104 via an application programming interface (API) 122, may, in near-real time (e.g., on sub-second time scales), generate user interfaces that respond to user queries and/or visualize the analyzed data, e.g., in the form of dashboards, reports, trend indicators, and/or charts.

The incoming data as generated by the IoT devices 102 does often not meet the format requirements of the data stores 116, necessitating format conversions prior to storage and/or analysis. A format conversion between a given input format (corresponding to the format of the IoT data as received) and the desired output format (corresponding to the format accepted by the applicable data store) can be effected by a suitable, generally device-specific data parser. As an example, one parser may be configured to process custom alert events to output time-series data. Another parser may be configured to parse a custom asset model into a standard asset model (e.g., ISO 55000). In accordance with various embodiments, a plurality of device-specific data parsers are stored in a parser catalog 130 accessible by the data ingestion engine 114. New data parsers may be added to the parser catalog 130 as needed, e.g., when new types of IoT devices 102 are connected to the data ingestion system 100. The device-specific data parsers may be written by, for instance, developers with knowledge of the data formats generated by the IoT devices 102 that constitute the data sources, or by operators of the IoT devices 102. The data parsers may be uploaded to the parser catalog 130 via a parser API 132. Via the parser API 132, the developers (or operators of the data sources or other personnel), may also provide, to a parser selection engine 134, rules that specify which values of the metadata trigger selection of a specific data parser.

The data parsers may generally be built in any programming language (including, e.g., Python, C, C++, Java, Javascript, Perl, and others). In some embodiments, data parsers are provided in the form of containers with executable bits and manifest. Upon launching, such a data parser exposes input and output ports as defined in the manifest. The data ingestion engine 114 sends a data stream coming through the data ingestion pipeline to the input port, and expects the parsed and transformed data at the output port. The parsers are stateless (in that they operate on each item of data in the data stream independently from preceding or following data), rendering the data ingestion system 100 scalable based on a data rate at the input of the data ingestion engine 114. Thus, the parsing load may be distributed between multiple simultaneously deployed instances of a given parser to facilitate (near-)real-time parsing and formatting. Parsers in many cases output device vitals in the native format of the cloud for which they are defined. For example, CPU and temperature measurements may be converted to time-series data and stored in a time-series database.

In accordance with various embodiments, data received at the data ingestion engine 114 includes, in addition to the IoT data itself, metadata associated with the IoT device from which the IoT data was received. Based on this metadata, the parser selection engine 134 may select a suitable data parser from the parser catalog 130. For illustration, consider, for example, data received in a message having the following envelope:

{
″id″ : ″ ″,
″model/type″ : ″ ″,
″serial″ : ″ ″,
″vendor″ : ″ ″,
″year″ : ″ ″,
″payload″ : <sample data>
}

Herein, the id uniquely identifies the message; model/type, serial number, vendor, and year constitute metadata identifying and characterizing the IoT device 102 that is the source of the data; and the payload includes the actual measurements or other IoT data acquired or generated by the IoT device 102. The parser selection engine 134 may pick a data parser from the parser catalog 130 based on specified values for a combination of one or more of the metadata fields. A particular parser may, for example, be suited for all IoT devices 102 of a given model or type, or different parsers may be adapted for IoT devices 102 of a given type provided by different respective vendors. In some instances, a parser may even be specific to an individual IoT device 102, or a group of IoT devices 102, as identified by serial number(s). The metadata need not in every embodiment include all of the fields included in the above example (as long as it includes the fields upon which the parser selection engine 134 operates), and may include further fields alternatively or in addition to those listed. For a given embodiment, the types of metadata fields included in the message envelope are consistent across IoT devices 102, whereas the format of the payload data can vary from device to device. The metadata may be provided along with the payload by the IoT devices 102. Alternatively, the metadata may be generated by the data ingestion engine 114 based on a unique identifier of the data source (e.g., an associated IP address of the IoT device 102) in conjunction with data-source profile information stored in the data ingestion system 100; such information may, for instance, be collected upon registration of an IoT device 102 with the data ingestion system 100. The data ingestion engine 114 may also, for example, decipher the data types and quality and enrich the data based thereon.

The parser selection engine 134 may be a rules engine that operates on the metadata contained in the device envelope, using rules defined by application developers 106 for the respective IoT devices 102, or owners/operators or vendors of the IoT devices 102. The rules may be uploaded to the parser selection engine 134, e.g., via the parser API 132. The rules may be defined and/or executed using any suitable proprietary or commercial business rules management system; non-limiting examples include JRules (provided by IBM, headquartered in Armonk, N.Y.) and Drools (provide by Red Hat, Inc., headquartered in Raleigh, N.C.). Application of the rules to the metadata may result in the selection of one or multiple data parsers. Multiple data parsers can be useful, for instance, if a given input data stream lends itself to representation in multiple available output data formats. Conversely, multiple IoT devices 102 (often an entire group) may share the same associated data parser(s).

In addition to the catalog 130 of device-specific data parsers, the data ingestion system 100 may also include an analytics repository 136 containing a plurality of data-analytics applications for processing streamed IoT data in (near-)real time. The data-analytics applications generally operate on the data as provided in an output data format of one of the data parsers. The derivative data generated by the data-analytics applications may be stored in the analytics store 118 for retrieval by the dashboard services 120 or direct access by field/operations engineers 104 or data scientists (or other users). The data-analytics applications may be defined by data scientists, developers 106, and/or asset owners/operators, and may incorporate, for example, machine-learning or anomaly-detection algorithms. Like the data parsers, the data-analytics applications may be provided as containers with executable bits and a manifest defining, e.g., the input and output ports, and may be stateless.

In accordance with various embodiments, data-analytics applications may be automatically invoked (e.g., by the data ingestion engine 114) to analyze certain data streams. Among the plurality of available data-analytics applications, suitable applications for a given data stream may be selected, similarly to data parsers, based on the metadata associated with the data source (e.g., the IoT device type or model), and/or based on usage needs. Information about usage needs may be gathered, for example, as part of the asset registration process, or provided at a later time. A user may, for instance, indicate a default interest in monitoring asset vitals or detecting anomalies in the data. Following data analysis with one or more of the data-analytics applications, the dashboard services 120 may automatically, without human intervention, create visualizations of the analyzed data (e.g., based on templates) for specified device types and usage needs. The selection of data-analytics applications may be rules-based, and may be carried out by the parser selection engine 134 or a similar separate rules engine. In some embodiments, selection of the data-analytics application is integrated with the parser selection. The rules for analytics selection, as well as the data-analytics applications themselves, may be uploaded via the parser API 132.

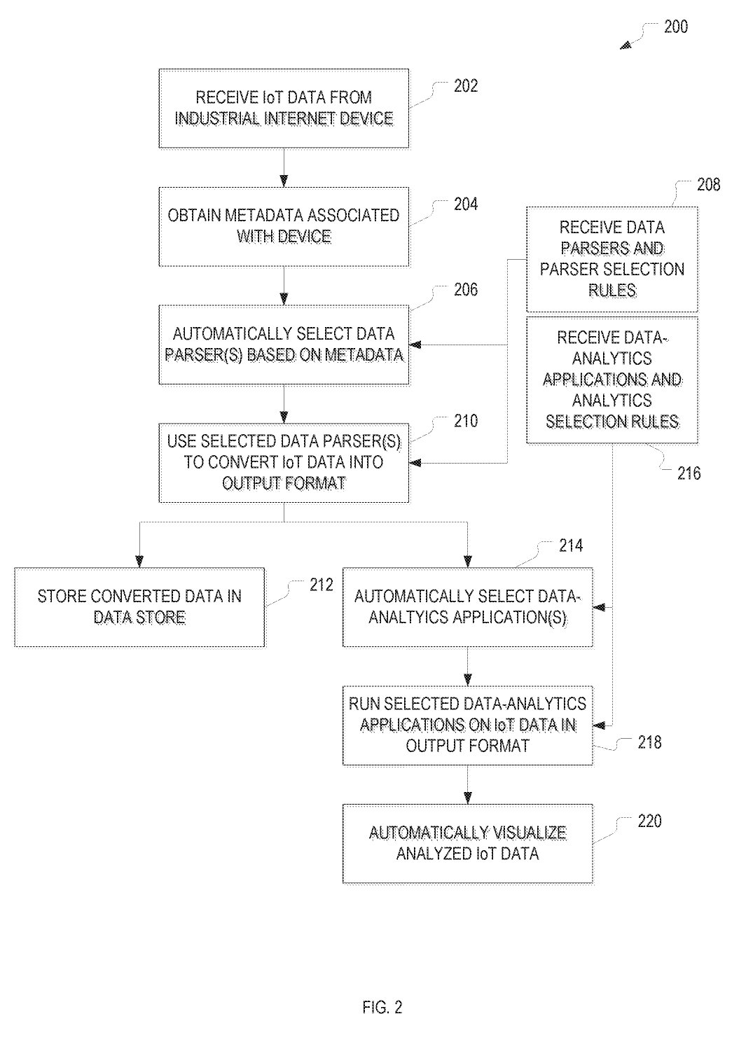

With reference now to FIG. 2, an example method 200 of ingesting IoT data in accordance with various embodiment will be described. The method involves receiving IoT data from a plurality of industrial internet devices 102 at a data ingestion system 100 (operation 202), and obtaining metadata associated with the respective devices 102 (operation 204). Such metadata may include, for example, a device serial number and/or information about the device model, type, or vendor for each device. The metadata may be included at the outset with the data as received from the IoT devices 102, or generated based on information retrieved, e.g., from respective stored data-source profiles. Either way, based on the metadata associated with a given device 102, one or more associated data parsers are automatically selected among a plurality of device-specific data parsers stored in the parser catalog 130 (operation 206) by applying parser selection rules to the metadata. The parser selection rules, along with the parsers themselves, may previously have been received at the data ingestion system 100 (operation 208), e.g., from application developers, owners, operators, or vendors of the IoT devices 102. Using the respective selected data parser(s), the IoT data received from each IoT device 102 is converted to one or more respective output formats associated with the data ingestion engine (e.g., time-series, binary-large-object, or relational-database formats) (operation 210); these output formats are generic to the plurality of industrial internet devices (that is, they are not specific to particular devices). The converted data may then be stored in one or more data stores 116 adapted to the output format(s) (operation 212). Alternatively or additionally, one or more data-analytics applications may be automatically selected among a plurality of data-analytics applications based on the metadata associated with the respective data sources and/or usage information (e.g., as provided by an owner/operator of the IoT devices) (operation 214). The data-analytics applications and analytics selection rules may have been previously received (in operation 216) at the data ingestion system 100, e.g., from application developers (or owners, operators, or vendors of the IoT devices 102). The selected data-analytics application(s) may be run (operation 218) on the IoT data in the output format provided by the selected data parser(s). Further, a user interface visualizing the resulting analyzed data (e.g., in dashboards, reports, charts, or the like) may be automatically generated (operation 220).

Accordingly, various embodiments provide a parser catalog containing a plurality of device-specific data parsers, along with a rules engine operating on metadata associated with IoT data sources, to automatically select and execute, for a given incoming data stream, one or more associated data parsers that convert the data into one or more device-generic output formats. Some embodiments, moreover, provide an analytics repository containing a plurality of device-specific analytics applications, along with selection rules operating on metadata associated with the IoT data sources and/or information about data-usage needs, to automatically select and execute one or more analytics applications on the converted data. The technical effect of these features is the ability to connect, to the data ingestion system, any kind of IoT device providing data in any input format, and facilitate the storage and processing of the IoT data by simply uploading suitable data parsers and/or data-analytics applications and defining the rules and metadata that trigger their selection and execution.

Certain embodiments are described herein as including logic or a number of components, modules, or mechanisms. Examples of modules include, without limitation, the data ingestion engine 114, parser selection engine 134, the parsers within parser catalog 130, and the data-analytics applications within analytics repository 136 of the system 100 of FIG. 1. Modules can constitute either software modules (e.g., code embodied on a non-transitory machine-readable medium) or hardware-implemented modules. A hardware-implemented module is a tangible unit capable of performing certain operations and can be configured or arranged in a certain manner. In example embodiments, one or more computer systems (e.g., a standalone, client, or server computer system) or one or more processors can be configured by software (e.g., an application or application portion) as a hardware-implemented module that operates to perform certain operations as described herein.

In various embodiments, a hardware-implemented module can be implemented mechanically or electronically. For example, a hardware-implemented module can comprise dedicated circuitry or logic that is permanently configured (e.g., as a special-purpose processor, such as a field programmable gate array (FPGA) or an application-specific integrated circuit (ASIC)) to perform certain operations. A hardware-implemented module can also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) can be driven by cost and time considerations.

Accordingly, the term “hardware-implemented module” should be understood to encompass a tangible entity, be that an entity that is physically constructed, permanently configured (e.g., hardwired), or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor can be configured as respective different hardware-implemented modules at different times. Software can accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules can be regarded as being communicatively coupled. Where multiple such hardware-implemented modules exist contemporaneously, communications can be achieved through signal transmission (e.g., over appropriate circuits and buses that connect the hardware-implemented modules). In embodiments in which multiple hardware-implemented modules are configured or instantiated at different times, communications between such hardware-implemented modules can be achieved, for example, through the storage and retrieval of information in memory structures to which the multiple hardware-implemented modules have access. For example, one hardware-implemented module can perform an operation and store the output of that operation in a memory device to which it is communicatively coupled. A further hardware-implemented module can then, at a later time, access the memory device to retrieve and process the stored output. Hardware-implemented modules can also initiate communications with input or output devices, and can operate on a resource (e.g., a collection of information).

The various operations of example methods described herein can be performed, at least partially, by one or more processors that are temporarily configured (e.g., by software) or permanently configured to perform the relevant operations. Whether temporarily or permanently configured, such processors can constitute processor-implemented modules that operate to perform one or more operations or functions. The modules referred to herein can, in some example embodiments, comprise processor-implemented modules.

Similarly, the methods described herein can be at least partially processor-implemented. For example, at least some of the operations of a method can be performed by one of processors or processor-implemented modules. The performance of certain of the operations can be distributed among the one or more processors, not only residing within a single machine, but deployed across a number of machines. In some example embodiments, the processor or processors can be located in a single location (e.g., within an office environment, or a server farm), while in other embodiments the processors can be distributed across a number of locations.

The one or more processors can also operate to support performance of the relevant operations in a “cloud computing” environment or as a “software as a service” (SaaS). For example, at least some of the operations can be performed by a group of computers (as examples of machines including processors), these operations being accessible via a network (e.g., the Internet) and via one or more appropriate interfaces (e.g., application program interfaces (APIs)).

Example embodiments can be implemented in digital electronic circuitry, in computer hardware, firmware, or software, or in combinations of them. Example embodiments can be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of description language, including compiled or interpreted languages, and it can be deployed in any form, including as a standalone program or as a module, subroutine, or other unit suitable for use in a computing environment. A computer program can be deployed to be executed on one computer or on multiple computers at one site or distributed across multiple sites and interconnected by a communication network.

In example embodiments, operations can be performed by one or more programmable processors executing a computer program to perform functions by operating on input data and generating output. Method operations can also be performed by, and apparatus of example embodiments can be implemented as, special purpose logic circuitry, e.g., an FPGA or an ASIC.

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware can be a design choice. Below are set out hardware (e.g., machine) and software architectures that can be deployed, in various example embodiments.

FIG. 3 is a block diagram of a machine in the example form of a computer system 300 within which instructions 324 may be executed to cause the machine to perform any one or more of the methodologies discussed herein. In alternative embodiments, the machine operates as a standalone device or can be connected (e.g., networked) to other machines. In a networked deployment, the machine can operate in the capacity of a server or a client machine in server-client network environment, or as a peer machine in a peer-to-peer (or distributed) network environment. The machine can be a personal computer (PC), a tablet PC, a set-top box (STB), a personal digital assistant (PDA), a cellular telephone, a web appliance, a network router, switch, or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 300 includes a processor 302 (e.g., a central processing unit (CPU), a graphics processing unit (GPU), or both), a main memory 304, and a static memory 306, which communicate with each other via a bus 308. The computer system 300 can further include a video display 310 (e.g., a liquid crystal display (LCD) or a cathode ray tube (CRT)). The computer system 300 also includes an alpha-numeric input device 312 (e.g., a keyboard or a touch-sensitive display screen), a user interface (UI) navigation (or cursor control) device 314 (e.g., a mouse), a disk drive unit 316, a signal generation device 318 (e.g., a speaker), and a network interface device 320.

The disk drive unit 316 includes a machine-readable medium 322 on which are stored one or more sets of data structures and instructions 324 (e.g., software) embodying or utilized by any one or more of the methodologies or functions described herein. The instructions 324 can also reside, completely or at least partially, within the main memory 304 and/or within the processor 302 during execution thereof by the computer system 300, with the main memory 304 and the processor 302 also constituting machine-readable media 322.

While the machine-readable medium 322 is shown in an example embodiment to be a single medium, the term “machine-readable medium” can include a single medium or multiple media (e.g., a centralized or distributed database, and/or associated caches and servers) that store the one or more instructions 324 or data structures. The term “machine-readable medium” shall also be taken to include any tangible medium that is capable of storing, encoding, or carrying instructions 324 for execution by the machine and that cause the machine to perform any one or more of the methodologies of the present disclosure, or that is capable of storing, encoding, or carrying data structures utilized by or associated with such instructions 324. The term “machine-readable medium” shall accordingly be taken to include, but not be limited to, solid-state memories, and optical and magnetic media. Specific examples of machine-readable media 322 include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and CD-ROM and DVD-ROM disks.

The instructions 324 can be transmitted or received over a communication network 326 using a transmission medium. The instructions 324 can be transmitted using the network interface device 320 and any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., WiFi and WiMax networks). The term “transmission medium” shall be taken to include any intangible medium that is capable of storing, encoding, or carrying instructions 324 for execution by the machine, and includes digital or analog communications signals or other intangible media to facilitate communication of such software.

The following numbered examples are illustrative embodiments.

1. A method comprising: at a data ingestion system operating in a computer network, receiving data from a plurality of industrial internet devices connected to the computer network, data formats of the data differing between at least two of the industrial internet devices; for each device from the plurality of industrial internet devices, automatically selecting, based on metadata associated with the respective device, an associated data parser among a plurality of device-specific data parsers, and using the selected data parser, converting the data received from the device into an output data format generic to the plurality of industrial internet devices.

2. The method of example 1, wherein the metadata associated with the industrial internet device comprises at least one of a device serial number or information about a device model, a device type, or a device vendor.

3. The method of example 1 or example 2, wherein the plurality of device-specific data parsers are stored in a parser catalog of the data ingestion system.

4. The method of any one of the preceding examples, further comprising receiving the device-specific data parsers via the computer network from at least one of owners of the industrial internet devices, vendors of the industrial internet devices, or developers for the industrial internet devices.

5. The method of any one of the preceding examples, wherein the automatic selecting is based on rules applied to the metadata.

6. The method of any one of the preceding examples, wherein the output data format is selected among a plurality of output formats associated with the data ingestion system.

7. The method of example 6, wherein the output formats associated with the data ingestion system comprise time-series, binary-large-object, and relational-database formats.

8. The method of any one of the preceding examples, further comprising, for at least one device from the plurality of industrial internet devices, automatically selecting, based on at least one of the metadata or data-usage information associated with an owner of the device, an analytics application among a plurality of data-analytics applications, and using the selected analytics application to analyze the data provided in the output data format.

9. The method of example 8, further comprising, for the at least one device, automatically generating a user interface visualizing the analyzed data.

10. A computer system comprising: one or more hardware processors; and one or more machine-readable storage media storing: a parser catalog comprising a plurality of device-specific data parsers, the data parsers comprising instructions which, when executed by the one or more hardware processors, cause the one or more hardware processors to convert data from a plurality of industrial internet devices into one or more device-generic output formats; a parser selection engine comprising instructions which, when executed by the one or more hardware processors, cause the one or more hardware processors to automatically select, based on metadata associated with the industrial internet devices, respective associated data parsers among the plurality of device-specific data parsers; and a data ingestion engine communicatively coupled to the parser selection engine and the parser catalog, the data ingestion engine comprising instructions which, when executed by the one or more hardware processors, cause the one or more hardware processors to process the data received from any of the industrial internet devices by: forwarding the respective associated metadata to the parser selection engine, forwarding the data, upon selection of the data parser associated with the industrial internet device, to the selected data parser, and providing the data, after conversion by the selected data parser into one of the device-generic output formats, as output.

11. The system of example 10, wherein the one or more machine-readable media further store one or more data stores for storing the data provided as output by the data ingestion engine, the one or more data stores comprising at least one of a time-series data store, a binary-large-object store, or a relational database.

12. The system of example 10 or example 11, wherein the one or more machine-readable media further store an analytics repository storing a plurality of data-analytics applications each comprising instructions which, when executed by the one or more hardware processors, cause the one or more hardware processors to process the data provided in one of the device-generic output formats, the parser selection engine further being configured to automatically select one of the analytics applications, based on at least one of the metadata or data-usage information associated with an owner of the device.

13. The system of example 12, wherein the one or more machine-readable media further store an analytics store for storing derivative data generated by the data-analytics applications when processing the data.

14. The system of any one of examples 10-13, wherein the plurality of parsers are stateless, the data ingestion system being scalable based on a data rate at an input of the data ingestion engine.

15. A tangible computer-readable medium storing instructions that, when executed by one or more processors of a computer within a computer network, cause the computer to perform operations comprising: receiving data from a plurality of industrial internet devices connected to the computer network, data formats of the data differing between at least two of the industrial internet devices; and for each device from the plurality of industrial internet devices, automatically selecting, based on metadata associated with the respective device, an associated data parser among a plurality of device-specific data parsers, and, using the selected data parser, converting the data received from the device into an output data format generic to the plurality of industrial internet devices.

16. The computer-readable medium of example 15, wherein the metadata identifying the industrial internet device comprises at least one of a device type, a device model, or a device serial number.

17. The computer-readable medium of example 15 or example 16, further storing a parser catalog containing the plurality of device-specific data parsers.

18. The computer-readable medium of any one of examples 15-17, wherein the output data format is one of a time-series format, a binary-large-object format, or a relational-database format.

19. The computer-readable medium of any one of examples 15-18, wherein the operations further comprise, for at least one device from the plurality of industrial internet devices, automatically selecting, based on at least one of the metadata or data-usage information associated with an owner of the device, an analytics application among a plurality of data-analytics applications, and causing the selected analytics application to analyze the data provided in the output data format.

20. The computer-readable medium of example 19, wherein the operations further comprise, for the at least one device, automatically generating a user interface visualizing the analyzed data.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method comprising:
at a data ingestion system operating in a computer network,
receiving data from a plurality of industrial internet devices connected to the computer network, data formats of the data differing between at least two of the industrial internet devices;
for each device from the plurality of industrial internet devices,
automatically selecting, based on metadata associated with the respective device, an associated data parser among a plurality of device-specific data parsers, and
using the selected data parser, converting the data received from the device into an output data format generic to the plurality of industrial internet devices.

2. The method of claim 1, wherein the metadata associated with the industrial internet device comprises at least one of a device serial number or information about a device model, a device type, or a device vendor.

3. The method of claim 1, wherein the plurality of device-specific data parsers are stored in a parser catalog of the data ingestion system.

4. The method of claim 1, further comprising receiving the device-specific data parsers via the computer network from at least one of owners of the industrial internet devices, vendors of the industrial internet devices, or developers for the industrial internet devices.

5. The method of claim 1, wherein the automatic selecting is based on rules applied to the metadata.

6. The method of claim 1, wherein the output data format is selected among a plurality of output formats associated with the data ingestion system.

7. The method of claim 6, wherein the output formats associated with the data ingestion system comprise time-series, binary-large-object, and relational-database formats.

8. The method of claim 1, further comprising, for at least one device from the plurality of industrial internet devices, automatically selecting, based on at least one of the metadata or data-usage information associated with an owner of the device, an analytics application among a plurality of data-analytics applications, and using the selected analytics application to analyze the data provided in the output data format.

9. The method of claim 8, further comprising, for the at least one device, automatically generating a user interface visualizing the analyzed data.

10. A computer system comprising:
one or more hardware processors; and
one or more machine-readable storage media storing:
a parser catalog comprising a plurality of device-specific data parsers, the data parsers comprising instructions which, when executed by the one or more hardware processors, cause the one or more hardware processors to convert data from a plurality of industrial internet devices into one or more device-generic output formats;
a parser selection engine comprising instructions which, when executed by the one or more hardware processors, cause the one or more hardware processors to automatically select, based on metadata associated with the industrial internet devices, respective associated data parsers among the plurality of device-specific data parsers; and
a data ingestion engine communicatively coupled to the parser selection engine and the parser catalog, the data ingestion engine comprising instructions which, when executed by the one or more hardware processors, cause the one or more hardware processors to process the data received from any of the industrial internet devices by:
forwarding the respective associated metadata to the parser selection engine,
forwarding the data, upon selection of the data parser associated with the industrial internet device, to the selected data parser, and
providing the data, after conversion by the selected data parser into one of the device-generic output formats, as output.

11. The system of claim 10, wherein the one or more machine-readable media further store one or more data stores for storing the data provided as output by the data ingestion engine, the one or more data stores comprising at least one of a time-series data store, a binary-large-object store, or a relational database.

12. The system of claim 10, wherein the one or more machine-readable media further store an analytics repository storing a plurality of data-analytics applications each comprising instructions which, when executed by the one or more hardware processors, cause the one or more hardware processors to process the data provided in one of the device-generic output formats, the parser selection engine further being configured to automatically select one of the analytics applications, based on at least one of the metadata or data-usage information associated with an owner of the device.

13. The system of claim 12, wherein the one or more machine-readable media further store an analytics store for storing derivative data generated by the data-analytics applications when processing the data.

14. The system of claim 10, wherein the plurality of parsers are stateless, the data ingestion system being scalable based on a data rate at an input of the data ingestion engine.

15. A tangible computer-readable medium storing instructions that, when executed by one or more processors of a computer within a computer network, cause the computer to perform operations comprising:
receiving data from a plurality of industrial internet devices connected to the computer network, data formats of the data differing between at least two of the industrial internet devices; and
for each device from the plurality of industrial internet devices,
automatically selecting, based on metadata associated with the respective device, an associated data parser among a plurality of device-specific data parsers, and
using the selected data parser, converting the data received from the device into an output data format generic to the plurality of industrial internet devices.

16. The computer-readable medium of claim 15, wherein the metadata identifying the industrial internet device comprises at least one of a device type, a device model, or a device serial number.

17. The computer-readable medium of claim 15, further storing a parser catalog containing the plurality of device-specific data parsers.

18. The computer-readable medium of claim 15, wherein the output format is one of a time-series format, a binary-large-object format, or a relational-database format.

19. The computer-readable medium of claim 15, wherein the operations further comprise, for at least one device from the plurality of industrial internet devices, automatically selecting, based on at least one of the metadata or data-usage information associated with an owner of the device, an analytics application among a plurality of data-analytics applications, and causing the selected analytics application to analyze the data provided in the output data format.

20. The computer-readable medium of claim 19, wherein the operations further comprise, for the at least one device, automatically generating a user interface visualizing the analyzed data.
